(19) United States
(12) Patent Application Publication
(10) Pub. No.: US 2011/0266181 A1
(43) Pub. Date: Nov. 3, 2011

(54) MICROSCOPE SLIDE HOLDER AND METHOD OF USE

(75) Inventor: Alexei MOROZOV, New York, NY (US)

(73) Assignee: SLOAN-KETTERING INSTITUTE FOR CANCER RESEARCH, New York, NY (US)

(21) Appl. No.: 13/040,305

(22) Filed: Mar. 4, 2011

Related U.S. Application Data
(60) Provisional application No. 61/310,586, filed on Mar. 4, 2010.
(60) Provisional application No. 61/324,985, filed on Apr. 16, 2010.

(51) Int. Cl. B65D 85/48; B23P 17/04

(52) U.S. Cl. 206/456; 29/428

(57) ABSTRACT

The present invention is a microscope slide holder suitable for use with a centrifuge. The slide holder includes a base with a plurality of chambers, the chambers being formed to receive and retain microscope slides. The slide holder may also include a seal, configured to cover the plurality of chambers, and a lid, which is removable from the base. The slide holder may also include a cover, which is configured to cover selected portions of the microscope slide. The method of using the microscope slide holder is also disclosed.

### CROSS REFERENCE TO RELATED APPLICATIONS

This application claims priority from pending U.S. Provisional Patent Application 61/310,586 filed on Mar. 4, 2010 [Attorney Ref. 3314.007P], the disclosure of which is included by reference herein in its entirety. This application also claims priority from pending U.S. Provisional Patent Application 61/324,985 filed on Apr. 16, 2010 [Attorney Ref 3314.007AP], the disclosure of which is included by reference herein in its entirety.

### STATEMENT REGARDING FEDERAL FUNDING

This invention was made with government support under Grant No. UL1 RR024996 awarded by the National Institutes of Health. The government has certain rights in the invention.

### TECHNICAL FIELD

The invention relates generally to the field of medical instruments, and more specifically, to the field of microscope slides.

### BACKGROUND OF THE INVENTION

Cells, microscopic organisms and other microscopic bodies are often the subject of scientific inquiry. The examination of these materials often requires close inspection under a microscope. In order to examine the materials accurately, they must adhere or otherwise be deposited on a glass microscope slide. Hereafter, cells refers to cells and microscopic bodies, such as, cell clusters, cell nuclei, individual chromosomes, small microorganisms, or other microscopic bodies. Hereafter, cell suspension refers to suspensions of cell organelles such as nuclei or chromosomes, body fluids composed of cells and cell clusters, samples of natural habitats containing unicellular and multicellular microorganisms, and other suspensions.

Microscope slides are easy to work with because they have a label area, are rectangular, and may be stored in a box. Microscopes are usually designed to accommodate microscope slides of standard dimensions. Specifically, microscopes are designed with a clamp that holds the slide in place and a certain distance between the slide and the objective which takes into account the dimensions of a standard microscope slide. This is especially important for automated microscopes where focusing and movement of the slide occurs automatically.

Certain medical and scientific procedures require cells to be deposited on microscope slides. Prior to deposition onto slides, cells may be found in suspension. For example, cells may be found growing in a suspension culture or in a body fluid specimen such as blood, urine, cerebrospinal fluid, pleural fluid or peritoneal fluid. Cells may also be grown on the surface of a culture dish, and may be removed from the surface using an enzyme such as trypsin. The use of an enzyme creates a cell suspension. Cells of interest may also be contained within a tissue such as tumor or normal tissue sample. The sample is digested or broken down into single cells, resulting in a cell suspension.

Cells in suspension then need to be deposited onto a microscope slide for further examination. Microscope slides may have a frosted glass area on one end which serves as a label area. Once the cells are deposited onto the slide, they may be covered with a cover slip. Varying sizes of cover slips are available, from rectangular ones that cover the entire slide area except the label area, to those that cover a smaller area of the slide, such as, for example, a square coverslip that covers approximately half of the slide area, or various circular coverslips. Several methods are currently used to deposit cells onto microscope slides.

One method, called cytospin, deposits cells directly onto glass using a centrifuge. A common apparatus is the Shandon Cytospin available from Thermo Fisher Scientific, Waltham, Mass. 02454. In this method, which is commonly employed in clinical laboratories, a specially built Cytospin centrifuge is required. A plastic funnel containing a receptacle for the cell suspension is attached to the slide, separated from the slide by a paper wick, and clamped onto the slide by a metal clamp. The entire assembly is placed inside the centrifuge at an angle such that the cell suspension is kept separate from the slide. When the centrifuge starts spinning, the assembly tilts and the cell suspension is drawn towards the slide by a centrifugal force. As the suspension contacts the slide, some cells adhere to the slide while other cells are wicked away by filter paper. The loss of cells is unacceptable in certain medical and scientific procedures, thus using a Cytospin is not suitable for those procedures. In addition, in some cases it is desirable to deposit cells onto a large area of the slide, maximizing the number of cells on the slide. In the cytospin method, the funnel and the wick are resting on the slide; therefore, the area of the slide available for deposition of cells is limited. The standard funnel deposits cells onto a circular area less than 1 cm in diameter. The largest funnel, called the megafunnel, allows deposition onto an area measuring 22×15 mm, which is less than half of the slide area. Another problem with the large funnel is that when the assembly is loaded into the centrifuge, the slide is essentially vertical. The cells may settle towards the lowermost side of the funnel, resulting in an uneven distribution of cells on the slide. The funnel may contain partitions which reduce, but do not eliminate, cell settling.

Another method for depositing cell suspensions onto microscope slide is based on allowing the cells to settle onto the slide by gravity. This method is commonly used for cells which can spontaneously adhere to the slide. A treatment or coating may be applied to the microscope slide to increase adhesion. The slide is placed on the bottom of a culture dish, and cells suspended in growth medium are added to the dish. After a period of hours to days, cells begin to attach and grow on the slide. The slide is then removed from the culture dish and covered with a cover slip. However, since culture dishes are typically round, and microscope slides are rectangular, many cells added to the dish will not settle onto the slide. Another limitation is that some cells will settle onto the frosted glass label area and therefore cannot be analyzed.

In another method, circular coverslips are deposited into circular wells of multi-well culture dishes. The cover slips essentially cover the entire surface of the well. After the cells are attached, the coverslips are inverted and placed onto the microscope slide. In this method, many of the cells that are deposited into the well will settle onto the coverslip, and all the cells on the coverslip may be analyzed. Multi-well plates can be spun in a centrifuge using a swinging bucket for microtiter plates, such as Swing-bucket Rotor A-4-62-MTP, Eppendorf, Hauppauge, N.Y. 11788.

This method has several limitations. First, coverslips are cumbersome to work with. Second, any additional processing of the cells, such as staining, dehydration in alcohol, or in-situ hybridization with DNA probes, required prior to microscopy, must be performed on coverslips. Also, cells may be damaged or lost during the handling of the coverslips during these additional steps. Additionally, the absence of a label area on coverslips may result in confusion of the two sides of the coverslip, and results in slow processing. Thus, performing procedures such as in-situ hybridization with DNA probes on coverslips is difficult. In contrast, these procedures are easily performed on microscope slides, and many slides can be processed together in specially designed vessels or automated slide processing equipment.

Another method of depositing suspension cells onto slides involves the use of chamber slides, such as the Nunc Lab-Tek Chamber Slide System, Thermo Fisher Scientific, Waltham, Mass. 02454. In this method, cells are deposited into the chambers and allowed to settle, attach and grow on the slide. The chamber is then removed and the slide is processed and examined under the microscope. However, the residue from the glue used to attach the chamber to the slide remains on the slide and cannot be completely removed. This interferes with placement of the coverslip. In addition, the chamber slide cannot be spun in a centrifuge. Another limitation of the chamber slide is that some pre-treated slides, such as adherent slides, may not be used with attached chambers.

### SUMMARY OF THE INVENTION

The microscope slide holder and method of using it, as described herein allow one to deposit cell suspensions and other materials onto glass microscope slides.

The present invention provides, in one aspect, a microscope slide holder that includes a base. A plurality of chambers are formed on the base; the plurality of chambers are configured to receive and retain microscope slides. The microscope slide holder may also include a seal configured to cover the plurality of chambers and a lid that fits over the base.

In another aspect of the invention, the slide holder may be configured to fit within a microtiter plate swinging bucket so that it may be spun in a centrifuge.

In another aspect of the invention, a cover is provided which is placed on top of the slide to reduce the area cells may be deposited on. The cover may be a block which covers the label area only. The cover may also have the outer dimensions essentially equal to those of the microscope slide, and contain one or more apertures corresponding to the area onto which cells are to be deposited.

The present invention provides, in another aspect, a method of using the microscope slide holder that may include, selecting a base with a plurality of chambers formed on the base. The plurality of chambers may be configured to receive and retain microscope slides. The method may also include the steps of placing microscope slides within one or more of the chambers, adding a cell suspension to one or more of the microscope slides, and allowing the cells to settle onto the microscope slide by gravity.

The method may further include placing a cover over the label area of the slide prior to adding a cell suspension. The method may also include placing a seal over the plurality of chambers and attaching a lid to the base. The method may also include placing the microscope slide holder into the microtiter plate swinging-bucket adapter, placing the swinging bucket adapter into a centrifuge, activating the centrifuge, deactivating the centrifuge, and removing the microscope slide holder from the swinging-bucket rotor. The method may further include removing the lid from the base and removing the seal from the base. Finally, the method may also include the step of removing the plurality of microscope slides from the swinging-bucket rotor.

Other additional features, benefits and advantages of the present invention will become apparent from the following drawings and descriptions of the invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the end of the specification. The foregoing and other objects, features, and advantages of the invention are apparent from the following detailed description taken in conjunction with the accompanying drawings in which:

FIG. 1 is an exploded perspective view of one embodiment of the microscope slide holder, in accordance with an aspect of the invention;

FIG. 2 is a detailed exploded perspective view of one embodiment of the microscope slide holder of FIG. 1, where the lid and seal have been omitted, and cover has been included, in accordance with an aspect of the invention;

FIG. 3A is a perspective view of one embodiment of the cover of FIG. 2, in accordance with an aspect of the invention;

FIG. 3B is a perspective view of an alternative embodiment of the cover of FIG. 2, in accordance with an aspect of the invention;

FIG. 3C is a perspective view of an alternative embodiment of the cover of FIG. 2, in accordance with an aspect of the invention;

FIG. 3D is a perspective view of an alternative embodiment of the cover of FIG. 2, in accordance with an aspect of the invention;

FIG. 4A is a top view of an alternative embodiment of the cover of FIGS. 2 and 3C, in accordance with an aspect of the invention;

FIG. 4B is a top view of an alternative embodiment of the cover of FIGS. 2 and 3D, in accordance with an aspect of the invention;

FIG. 4C is a top view of an alternative embodiment of the cover of FIG. 2, in accordance with an aspect of the invention;

FIG. 5 is an exploded perspective view of an alternative embodiment of the microscope slide holder of FIG. 1, in accordance with an aspect of the invention;

FIG. 6 is a cross-sectional view of the microscope slide holder of FIG. 5 along line 6-6, in accordance with an aspect of the invention;

FIG. 7A is a cross-sectional view of the microscope slide holder of FIG. 2 along line 7A-7A, in accordance with an aspect of the invention showing the microscope slide holder prepared to receive a microscope slide with the microscope slide, cover, seal, and lid positioned above the chamber, in accordance with an aspect of the invention;

FIG. 7B is a cross-sectional view of the microscope slide holder of FIG. 2 along line 7B-7B in accordance with an aspect of the invention showing the microscope slide holder with the microscope slide positioned in the chamber and the cover positioned above the microscope slide within the chamber, the seal positioned above the chamber, and the lid attached to the base, in accordance with an aspect of the invention;

FIG. 8 is an exploded perspective view of an alternative embodiment of the microscope slide holder of FIG. 1, in accordance with an aspect of the invention;

FIG. 9 is an exploded perspective view of an alternative embodiment of the microscope slide holder of FIG. 1, in accordance with an aspect of the invention;

FIG. 10 is an exploded perspective view of an alternative embodiment of the microscope slide holder of FIG. 1, in accordance with an aspect of the invention;

FIG. 11 is a top view of an alternative embodiment of the microscope slide holder of FIG. 10, in accordance with an aspect of the invention;

FIG. 12 is an exploded perspective view of an alternative embodiment of the microscope slide holder of FIG. 1, in accordance with an aspect of the invention;

FIG. 13 is an exploded perspective view of an alternative embodiment of the microscope slide holder of FIG. 1, in accordance with an aspect of the invention;

FIG. 14 is an exploded perspective view of an alternative embodiment of the microscope slide holder of FIG. 1, in accordance with an aspect of the invention;

FIG. 15 is an exploded perspective view of an alternative embodiment of the microscope slide holder of FIG. 1, in accordance with an aspect of the invention;

FIG. 15A is a cross-sectional view of the microscope slide holder of FIG. 15 along line 15A-15A, in accordance with an aspect of the invention;

FIG. 16 is an exploded perspective view of an alternative embodiment of the microscope slide holder of FIG. 1, in accordance with an aspect of the invention;

FIG. 17 is a perspective view of an alternative embodiment of the microscope slide holder of FIG. 16 where a seal has been placed on a base and a cover has been placed on a seal, in accordance with an aspect of the invention;

FIG. 18 is a perspective view of an alternative embodiment of the microscope slide holder of FIG. 16 where a cover has been placed on a seal, a seal has been placed on a base, and fasteners have been placed on screws securing the base, seal and cover, in accordance with an aspect of the invention;

FIG. 19 is a perspective view of an alternative embodiment of the microscope slide holder of FIG. 16 where a cover has been placed on a seal, a seal has been placed on a base, fasteners have been placed on screws securing the base, seal and cover, and a solution is being placed on a microscope slide, in accordance with an aspect of the invention;

FIG. 20 is a perspective view of an alternative embodiment of the microscope slide holder of FIG. 1, in accordance with an aspect of the invention.

### DETAILED DESCRIPTION FOR CARRYING OUT THE INVENTION

For the purposes of promoting an understanding of the principles of the microscope slide holder and a method of using the microscope slide holder, reference will now be made to the embodiments, or examples, illustrated in the drawings and specific language will be used to describe these. It will nevertheless be understood that no limitation of the scope of the invention is thereby intended. Any alterations and further modifications in the described embodiments, and any further applications of the principles of the invention as described herein are contemplated as would normally occur to one skilled in the art to which the microscope slide holder invention relates.

Generally stated, disclosed herein is a microscope slide holder for use in depositing cells onto microscope slides. The microscope slide holder shown herein is intended for example purposes only, as many alterations would occur to one skilled in the art, and are contemplated as a part of the invention.

As used herein, the terms “swinging-bucket rotor centrifuge” and “swinging-bucket rotor” may be used interchangeably as they essentially describe the same type of centrifuge.

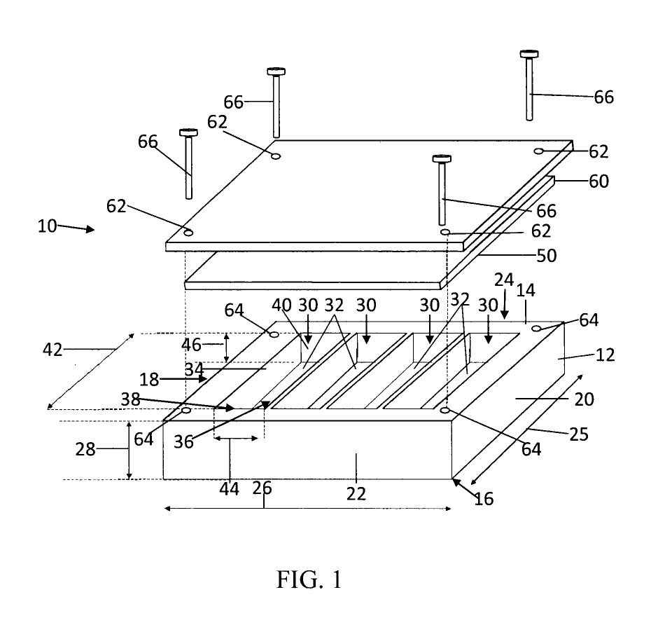

The present invention comprises a microscope slide holder, and is identified in FIGS. 1-20 by reference numeral 10.

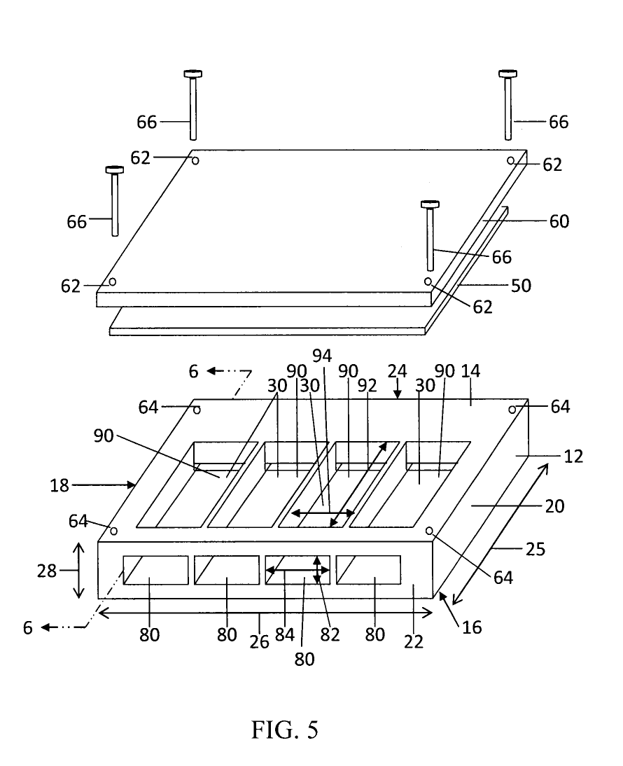

Referring to FIG. 1, microscope slide holder 10 comprises a base 12, and a plurality of chambers 30 formed on base 12, a seal 50, and a lid 60. Base 12 is comprised of a top surface 14, a bottom surface 16, a left surface 18, a right surface 20, a front surface 22 and a back surface 24. In the embodiments shown in FIG. 1, top surface 14, bottom surface 16, left surface 18, right surface 20, front surface 22 and back surface 24 are each generally rectangular. According to FIG. 1, the area of base 12 is defined by a dimension line 25, which is approximately 88 mm, a dimension line 26, which is approximately 130 mm, and a dimension line 28, which is approximately 30 mm. The above listed dimensions for dimension line 25, dimension line 26, and dimension line 28 correspond to the typical dimensions of a microtiter adapter for a swinging-bucket rotor centrifuge. Thus, the embodiments shown in FIGS. 1 and 5 may be placed in a typical swinging-bucket rotor. However, the dimensions of microscope slide holder 10 and base 12 may vary for swinging-bucket rotor centrifuges with different microtiter adapter dimensions, or for different types of centrifuges generally. Thus, dimension line 25 may vary from 50 mm to 200 mm, dimension line 26 may vary from 50 mm to 200 mm, and dimension line 28 may vary from 10 mm to 100 mm. Top surface 14 and bottom surface 16 may have a generally circular, oval, square, hexagonal, or polygonal shape. In other alternative embodiments, left surface 18, right surface 20, front surface 22, and back surface 24 may have a generally circular, oval, square, hexagonal or polygonal shape.

Referring again to FIG. 1, chamber 30 has a generally rectangular floor 32; the area is described by a dimension line 42 and a dimension line 44. Chamber 30 also a left side 34 and a right side 36, each described by dimension line 42 and a dimension line 46. Chamber 30 also has a front side 38 and a back side 40 described by dimension line 42 and a dimension line 48. In the embodiment shown in FIG. 1, chamber 30 is formed upon top surface 14 such that back side 40 is substantially parallel to back surface 24. Chamber 30 may be oriented such that left side 34 is substantially parallel to back surface 24. It Chamber 30 may be oriented such that no side of chamber 30 is substantially parallel to any surface of base 12. In the embodiment shown in FIG. 1, dimension line 42 is approximately 76 mm, dimension line 44 is approximately 26 mm, and dimension line 46 is approximately 15 mm. The above listed dimension lines for chamber 30 correspond to a chamber which is sized to receive and retain an industry standard microscope slide. However, in various embodiments dimension line 42 may range from 10 mm to 104 mm, line 44 may range from 10 mm to 104 mm, and dimension line 46 may range from 1 mm to 29 mm. In order to receive and retain other sizes of microscope slides, in an alternative embodiment, dimension line 42 may be approximately 76 mm and dimension line 44 may be 39 mm. In still another embodiment, dimension line 42 may be approximately 76 mm and dimension line 44 may be approximately 51 mm. Although chamber 30 in FIG. 1 is shown as rectangular, in alternative embodiments, chamber 30 may be comprised of a floor 32 with a non-rectangular shape. For example purposes, floor 32 may have a generally square, rectangular, circle, oval, hexagon or polygon shape. In the embodiment where floor 32 is non-rectangular, left side 34, right side 36, front side 38, and back side 40 are configured so that a microscope slide may be placed adjacent to floor 32.

Still referring to FIG. 1, microscope slide holder 10 further comprises a seal 50. Seal 50 covers the plurality of chambers 30. Seal 50 is shown as generally rectangular in FIG. 1; however, in various embodiments seal 50 may be square, rectangular, oval, circular, hexagon, or polygon shaped. Seal 50 may be a silicon gasket, a rubber based material, or another material capable of providing a seal, thereby preventing cross contamination between the plurality of chambers 30.

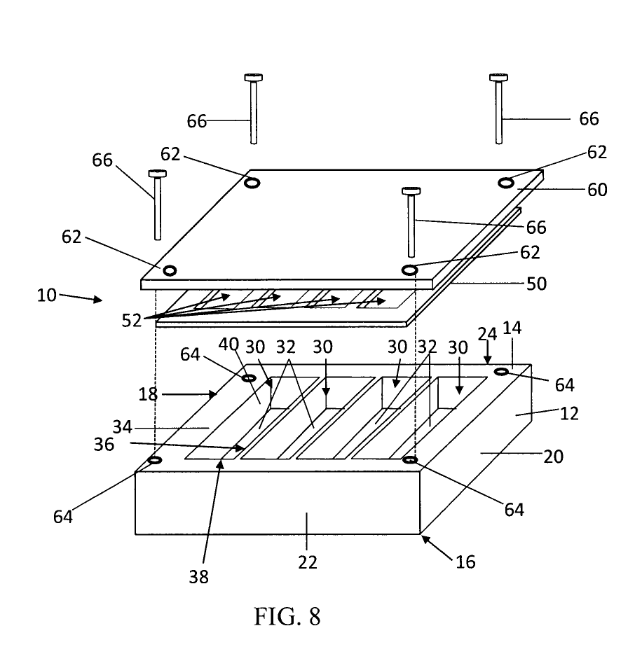

Referring now to FIG. 8, an alternative embodiment of slide holder 10 is shown. In this embodiment seal 50 has a plurality of apertures 52. Plurality of apertures 52 may allow access to plurality of chambers 30. Plurality of apertures 52 may be configured to provide access to the whole area of plurality of chambers 30. In an alternative embodiment, plurality of chambers 52 may provide access to only a limited area of plurality of chambers 30.

Again Referring to FIG. 1, microscope slide holder 10 further comprises a lid 60. As shown in FIG. 1, lid 60 is a generally rectangular shape, conforming to the general shape of base 12. A plurality of screw holes 62 is formed on lid 60. As shown in FIG. 1, a screw hole 62 is formed at each corner of lid 60. A corresponding plurality of screw holes 64 is formed on top surface 14. Microscope slide holder 10 also comprises a plurality of screws 66. Plurality of screw holes 62 and plurality of screw holes 64 are appropriately sized to receive screws 66. Screws 66 are placed through screw holes 62 and screw holes 64 to secure lid 60 and seal 50 to base 12. In the embodiment shown in FIG. 1, seal 50 is separate from lid 60; however, seal 50 may be fixedly attached to lid 60.

Screws 66, screw holes 62, and screw holes 64 shown in FIGS. 1 and 5 are only one contemplated means for attaching lid 60 to base 12. In one embodiment, lid 60 may be attached to base 12 with a hinge on one side and with a lock on the other side. For example purposes, the lock may be a snap lock, a press-fit lock, or a locking hinge. In another embodiment, lid 60 may be attached to base 12 with only a plurality of snap locks or press-fit locks.

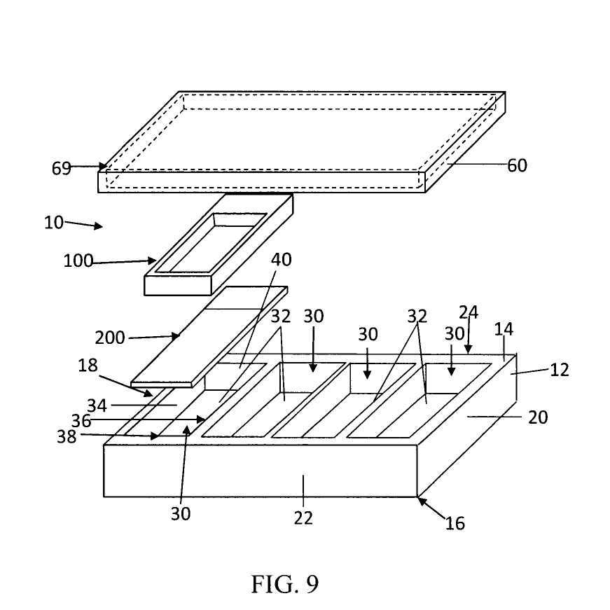

Now referring to FIG. 9, an alternative embodiment is shown where lid 60 does not have a means for attachment to base 12. Lid 60 may rest above base 12. It another alternative, lid 60 may have a shoulder 69 as shown in FIG. 9. Shoulder 69 may come in contact with left surface 18, right surface 20, front surface 22 and back surface 24.

In an alternative embodiment, bottom surface 16 of base 12 may be configured to fit securely over top surface 14 of a second base 12. Thus, a plurality of bases 12 may be stacked upon one another to be used in a centrifuge. In this embodiment, bottom surface 16 may simply rest above the top surface 14 of a second base 12, or bottom surface 16 may be configured to lock to top surface 14. Top surface 14 and bottom surface 16 may lock using, for example, a snap-fit lock or a press-fit lock.

Base 12 and lid 60 may have a non-rectangular shape. For example purposes, base 12 and base 60 may be square, rectangular, circular, oval, hexagonal, or polygonal in shape. In the embodiment where base 12 and lid 60 are not rectangular, plurality of chambers 30 may be rectangular or non-rectangular. Additional contemplated shapes for base 12 and lid 60 include square, oval, hexagonal, and polygonal. In various embodiments, base 12 and plurality of chambers 30 may be of different shapes, for example, base 12 may be rectangular, and plurality of chambers 30 may be oval.

In an alternative embodiment, seal 50 and lid 60 may be omitted from slide holder 10 entirely.

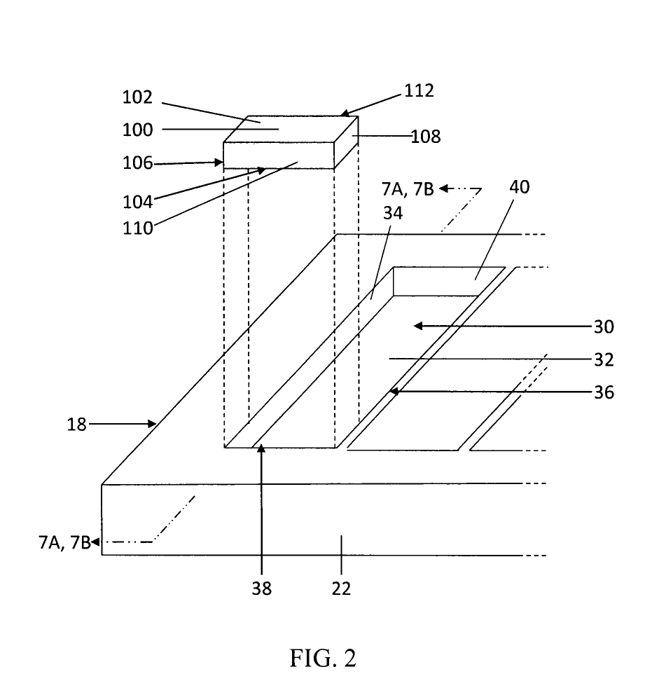

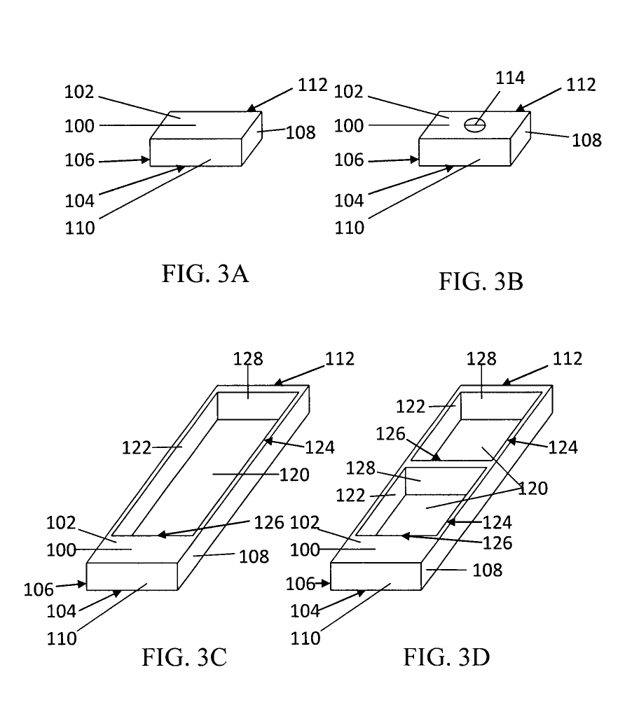

FIG. 2 shows a detailed perspective view of the left end of base 12. Also shown in FIG. 2 and FIG. 3A is one embodiment of a cover 100. For example purposes, cover 100, shown in FIG. 2 and FIG. 3A, comprises a solid with six rectangular faces. As shown by FIG. 2 and FIG. 3A, cover 100 comprises a top surface 102, a bottom surface 104, a left surface 106, a right surface 108, a front surface 110, and a back surface 112. In various embodiments top surface 102, bottom surface 104, left surface 106, right surface 108, front surface 110, and back surface 112 may be independently varied in size, and, for example purposes, each may have a non-rectangular shape, such as generally square, circle, oval, hexagon or polygon. Cover 100 may fit within chamber 30. As shown in FIG. 2, when cover 100 is inserted into chamber 30, bottom surface 104 may come in contact with the microscope slide, which is resting on floor 32, left surface 106 may come in contact with left side 34, right surface 108 may come in come in contact with right side 36, and front surface 110 may come in contact with front side 38.

Now referring to FIG. 3B, an alternative embodiment of cover 100 is shown. This alternative embodiment shows cover 100 with a means for removal 114 formed on top surface 102. In the embodiment shown, the means for removal 114 is a notch, which has been formed in top surface 102. In alternative embodiments means for removal 114 may be, but are not limited to, a loop or hook. In the embodiment shown the notch does not extend above the top surface 102. However, in alternative embodiments the means for removal 114 may extend above top surface 102. Means for removal may be formed in left surface 106, right surface 108, front surface 110, or back surface 112. In another embodiment, multiple means for removal may be formed on cover 100.

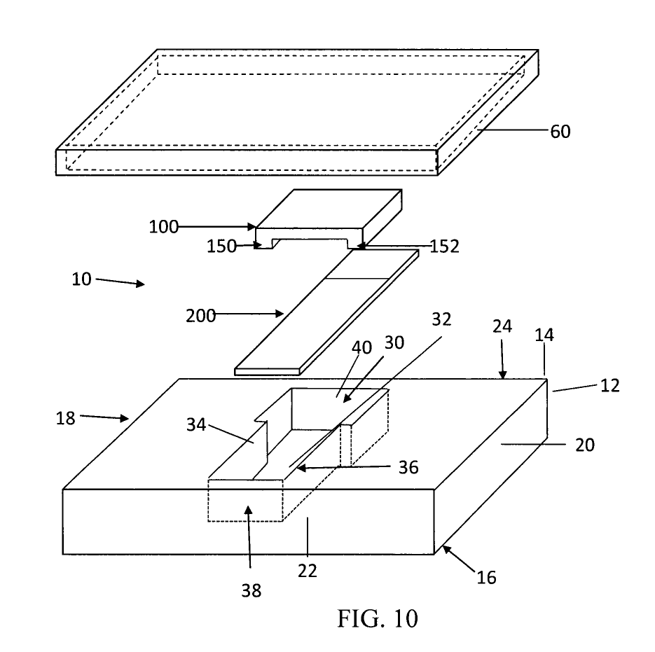

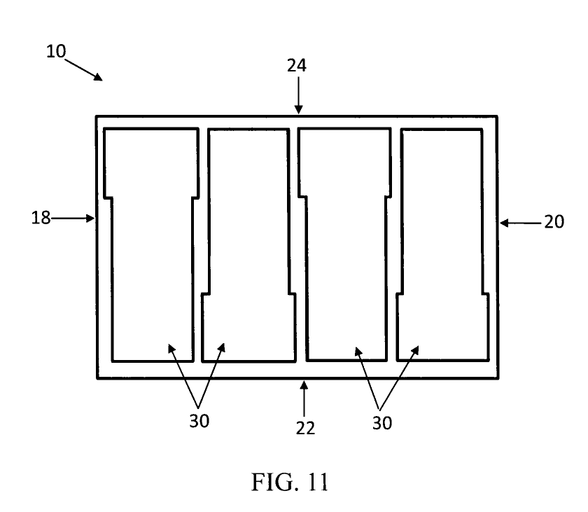

Referring now to FIG. 10, an alternative embodiment of slide holder 10 is shown. In this alternative, chamber 30 is polygonal, and a specifically adapted to receive an alternative embodiment of cover 100. In this embodiment cover 100 includes a first foot 150 and a second foot 152. First foot 150 and second foot 152 are positioned on either side of the microscope slide 200. In the embodiment where plurality of chambers 30 are configured to receive a plurality of covers 100, plurality of chambers 30 may be arranged in an alternating fashion, as shown in FIG. 11. This is one means for interlocking with the base to prevent sliding of the cover.

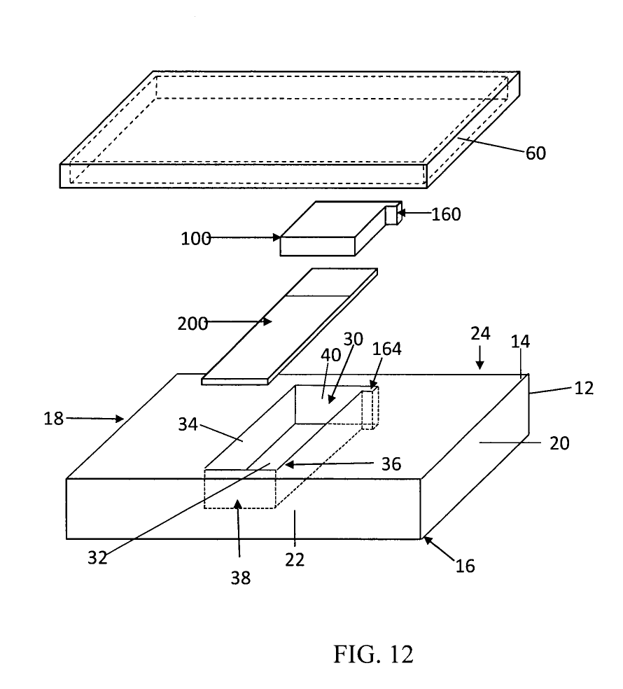

Referring now to FIG. 12, an alternative embodiment of base 12 and cover 100 is shown. In this embodiment, cover 100 may have a first arm 160, and chamber 30 may have a first arm receiving section 164. The movement of cover 100 along slide 200 is eliminated or reduced when cover 100 is placed into chamber 30 such that first arm 160 is within first arm receiving section 164. This is another means for interlocking with the base to prevent sliding of the cover.

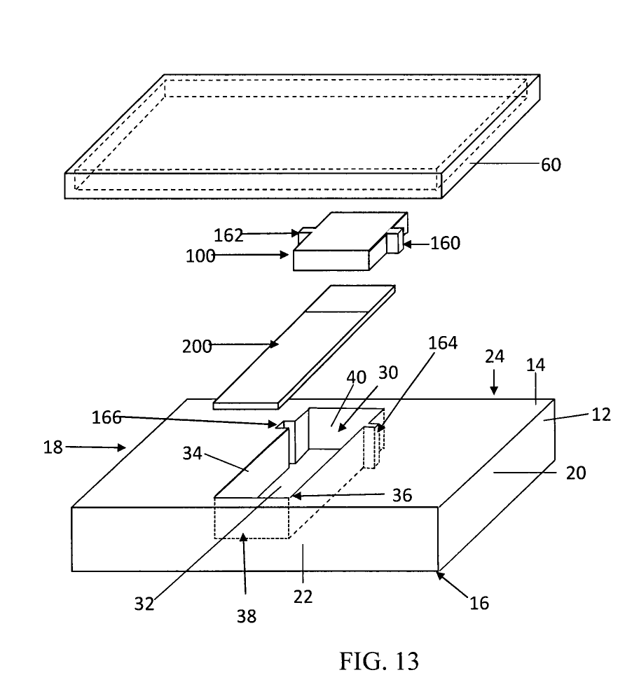

In an another alternative embodiment, shown in FIG. 13, chamber 30 is shown with first arm receiving section 164 and a second arm receiving section 166. In this embodiment cover 100 may have a first arm 160 and a second arm 162. The movement of cover 100 relative to slide 200 is eliminated or reduced when cover 100 is placed into chamber 30 such that first arm 160 is within first arm receiving section 164, and second arm 162 is within second arm receiving section 166. This is another means for interlocking with the base to prevent sliding of the cover.

In addition to reducing or eliminating the movement of cover 100, first arm receiving section 164 and second arm receiving section 166 may provide access to a microscope slide 200, such that microscope slide 200 may be easily removed with the use of forceps or another tool.

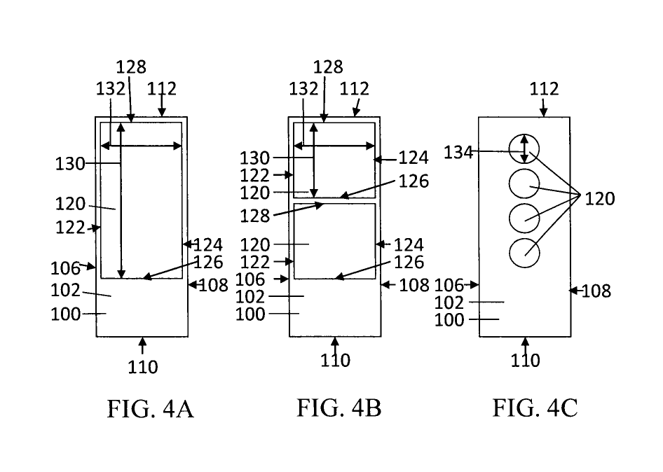

Referring now to FIGS. 3C and 4A, an alternative embodiment of cover 100 is shown. This alternative embodiment shows cover 100 with an extended left surface 106 and an extended right surface 108. Left surface 106 and right surface 108 may have substantially the same dimensions as left side 34 and right side 36 respectively. Thus, cover 100 will fit inside chamber 30 such that bottom surface 104 will come in contact with the microscope slide, which is resting on floor 32, left surface 106 will come in contact with left side 34, right surface 108 will come in come in contact with right side 36, front surface 110 will come in contact with front side 38, and back surface 112 will come in contact with back side 40. Aperture 120 may be formed on cover 100. In the embodiment shown in FIGS. 3C and 4A, an aperture 120 is generally rectangular, thus aperture 120 has a left side 122, a right side 124, a front side 126, and a back side 128. The length of left side 122 and right side 124 is shown by dimension line 130. The length of front side 126 and back side 128 is shown by dimension line 132. In various embodiments dimension line 130 may range from 1 mm to 75 mm, and dimension line 132 may range from 1 mm to 120 mm. Cover 100 shown in FIGS. 3C and 4A is configured to cover the slide label area and the perimeter of the slide.

Referring now to FIGS. 3D and 4B, another embodiment of cover 100 is shown. Left surface 106 and right surface 108 are extended such that back surface 112 will come in contact with back side 40 when cover 100 is placed into chamber 30. In the embodiment shown in FIGS. 3D and 4A, a plurality of apertures 120 are formed on cover 100. Each aperture 120 has sides as defined above. In the embodiment shown, the length of left side 122 and right side 124 is shown by dimension line 130. The length of front side 26 and back side 128 is shown by dimension line 132. In various embodiments that dimension line 130 may range from 1 mm to 75 mm, and dimension line 132 may range from 1 mm to 120 mm. Apertures 120 in FIGS. 3D and 4B are identical. In alternative embodiments each aperture 120 may have different dimensions.

Referring now to FIG. 4C another embodiment of cover 100 is shown. Left surface 106 and right surface 108 are extended such that back surface 112 will come in contact with back side 40 when cover 100 is placed into chamber 30. The plurality of apertures 120 in FIG. 4C are shown as circles, with dimension line 134 showing the diameter of apertures 120. In alternative embodiments, dimension line 134 may range from 1 mm to 25 mm. In the example shown in FIG. 4C, the apertures 120 are shown as identical, however, it is contemplated that each aperture may have a different diameter. It should be understood that the plurality of apertures 120 shown in FIG. 4C is an example, and that many variations would occur to one skilled in the art.

The embodiments of cover 100 shown in FIGS. 3D, 4B and 4C are examples of embodiments that cover the slide except for an effective area for cell depositing.

Apertures 120 described above and in FIGS. 3C, 4A, 3D, and 4B are rectangular, and apertures 120 described above and in FIG. 4C are circular. However, it is contemplated that other shapes may be suitable for plurality of apertures 120, including, for example, square, oval, hexagonal, and polygonal. For each of the above-described embodiments of cover 100, it is contemplated that cover 100 is comprised of a hard material that will not deform when it is spun in the swinging-bucket rotor or other centrifuge. Such materials may include, for example purposes, metal or hard plastic. In alternative embodiments, bottom surface 104 may be covered with a sealing and/or motion resistant material, such as, for example, rubber, or silicon. In still another alternative embodiment, the sealing and/or motion resistant material may coat top surface 102, left surface 106, right surface 108, front surface 110, and/or back surface 112.

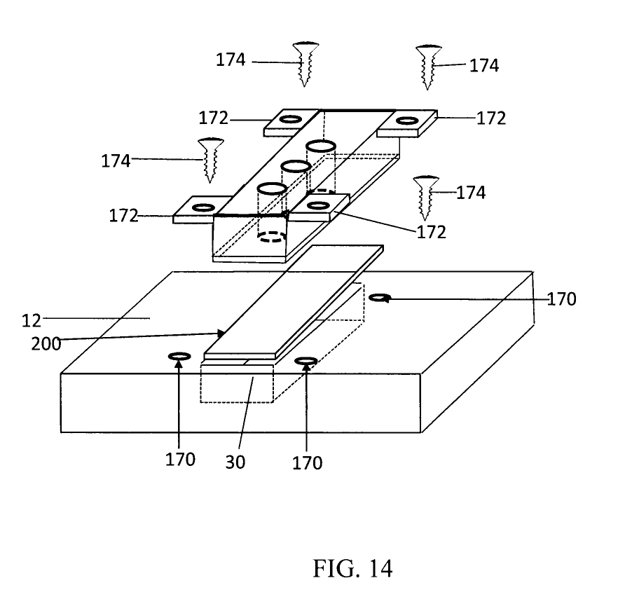

In another embodiment, cover 100 may have a means for attachment. Contemplated means for attachment include, but are not limited to, hooks, screws, bolts, or a snap-fit device. In the embodiment shown in FIG. 14, base 12 may have a plurality of screw receiving apertures 170 formed thereon. Cover 100 may have a plurality of screw receiving projections 172. A plurality of screws 174 may be inserted through screw receiving projections 172 and into screw receiving apertures 170, thereby securing cover 100 to base 12. In the embodiment where cover 100 is secured to base 12, and cover 100 is coated with a sealing material, a seal may be formed between cover 100 and slide 200, thereby preventing cross contamination between the plurality of apertures 120.

Referring now to FIG. 5, an alternative embodiment of microscope slide holder 10 is shown. In this embodiment a plurality of apertures 80, formed on front surface 22, provides access to plurality of chambers 30. The vertical and horizontal components of plurality of chambers 80 are shown by a dimension line 82 and a dimension line 84 respectively. Dimension line 82 may range from 5 mm to 20 mm, and dimension line 84 may range from 5 mm to 80 mm. A plurality of apertures 90 is formed on top surface 14. As shown in FIG. 5, plurality of apertures 90 are defined by a dimension line 92 and a dimension line 94. Dimension line 92 may range from 10 mm to 70 mm, and that dimension line 94 may range from 5 mm to 30 mm.

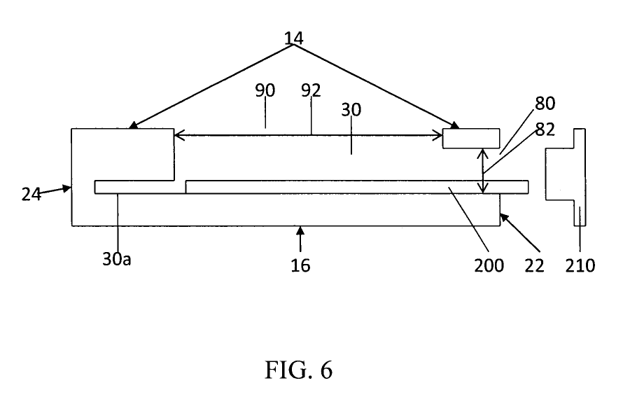

Referring now to FIG. 6, chamber 30 is shown as having an irregular shape, specifically, chamber 30 is shown as generally rectangular but having a rectangular extension 30(a) into which a microscope slide 200 may be inserted. Also shown in FIG. 6 is a cap 210. After microscope slide 200 is positioned in chamber 30, cap 210 may be inserted into aperture 80 to prevent microscope slide 200 from moving or otherwise becoming displaced. Cap 210 may be comprised of a sealing material such as rubber or silicon. In another embodiment cap 210 may be comprised partially of a sealing material such as rubber or silicon and partially an otherwise rigid material such as hard plastic or metal.

The foregoing descriptions and embodiments of the slide holder focused on embodiments in which a single chamber 30 was designed to receive and retain a single microscope slide. Referring to FIG. 1, it is contemplated that in alternative embodiments, a single chamber 30 may be designed to receive multiple microscope slides. Referring to FIGS. 2-4C, a single cover 100 may be capable of covering the slide label area of multiple slides, or cover the entirety of several microscope slides except for the area suitable for cell depositing on each of the microscope slides. Referring now to FIG. 5, in an alternative embodiment, multiple slides may be inserted through a single aperture 80.

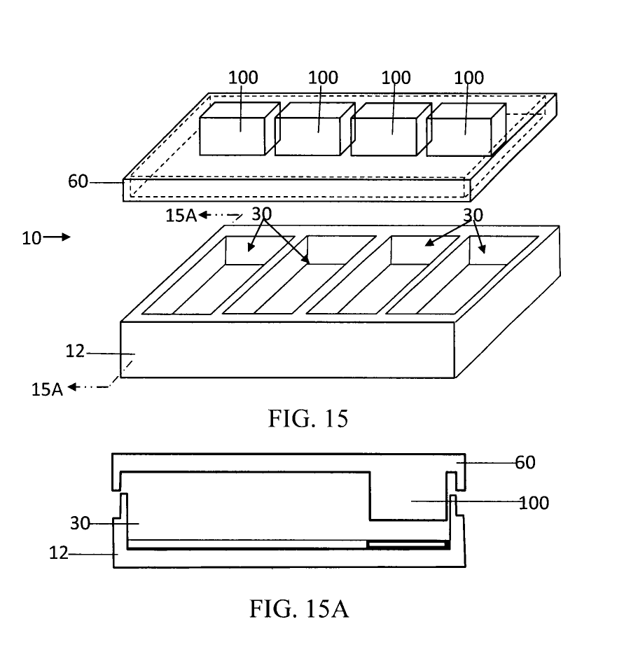

In still another alternative embodiment, plurality of covers 100 may be attached to lid 60. This embodiment is illustrated in FIGS. 15 and 15A. FIG. 15 shows one embodiment of slide holder 10 where plurality of covers 100 are affixed to lid 60. FIG. 15A shows the cross sectional area of base 12 and lid 60 along line 15A-15A. Although not shown, any embodiment of cover 100 that has been disclosed may be attached to lid 60. Lid 60 and cover 100 may be molded as a single piece of plastic.

An alternative embodiment is also provided where the slide is effectively sealed from all sides, therefore eliminating all potential cell loss. If there is no possibility for cell loss, a user of the slide holder can be assured of accuracy. This alternative embodiment also provides manufacturing advantages because fewer sharp corners need to be produced. This alternative embodiment is also easier to use and assemble because the slide does not have to be placed within a chamber, therefore eliminating the need for tools in the placement and removal of microscope slides.

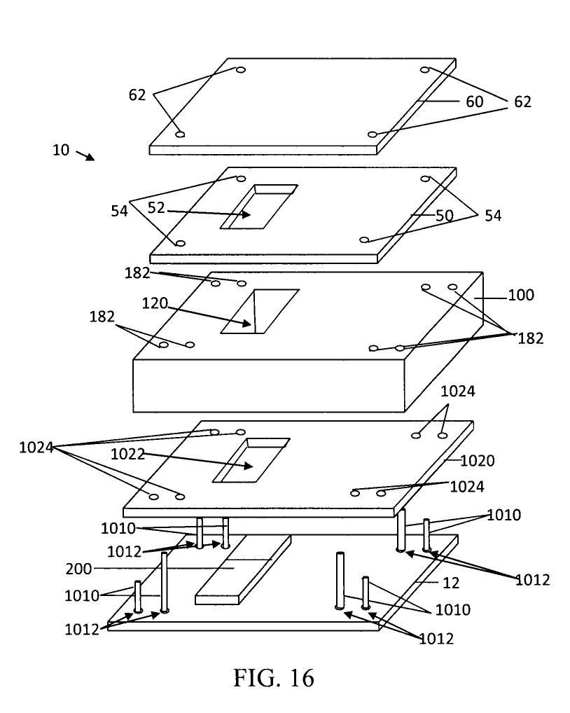

An alternative embodiment of the slide holder which may be easier to fabricate, manipulate and use is shown in an exploded view in FIG. 16. In the embodiment shown in FIG. 16, base 12 may have a plurality of apertures 1012 for receiving a plurality of screws 1010. One or more slides 200 may be placed on base 12 at predetermined locations. Base 12 is configured for the easy and simple placement of slides 200. In this embodiment, there is no need for an additional tool to place or remove slides 200.

A seal 1020 is shown positioned above base 12. A plurality of apertures 1024 may be formed on seal 1020 to receive plurality of screws 1010. Additionally, one or more apertures 1022 may be formed on seal 1020 to receive slide 200. In alternative embodiments, aperture 1022 may be square, rectangular, triangular, circular, oval or polygonal. Seal 1020 is designed to prevent any unwanted loss of cells or solution. Seal 1020 may also prevent the cross contamination of multiple slides 200. Seal 1020 is optional, and may be omitted in alternative embodiments. In still other alternative embodiments, seal 1020 may be attached to base 12 or cover 100. Seal 1020 may be attached to base 12 or cover 100 for ease in assembling slide holder 10.

Cover 100 is shown positioned above seal 1020. Cover 1020 may be configured to have an area that is substantially the same size and shape as base 12. A plurality of apertures 182 may be formed on cover 100 to receive plurality of screws 1010. Aperture 120 may be formed on cover 100. All prior disclosure regarding the shape and size of aperture 120 should be understood to apply to this embodiment. Aperture 120 may have a size and shape designed to limit the amount of cells or solution that may be deposited on slide 200. Aperture 120 provides access to an effective area for cell depositing. In other embodiments, a plurality of apertures 120 may provide access to multiple slides 200 or different areas on a single slide 200. This embodiment provides for ease of assembly, because there is no need to center cover 100 over a particular area of slide 200. Additionally, no tools are needed to remove cover 100 from base 12.

Seal 50 is shown positioned above cover 100. Plurality of apertures 54 for receiving screws 1010 may be formed on seal 50. In an alternative embodiment, seal 50 may be attached to cover 100. Lid 60 is shown positioned above seal 50. A plurality of apertures 62 may be formed on lid 60 for receiving screws 1010. Seal 50 may be effective in reducing or eliminating the cross contamination of different slides 200. Seal 50 may also prevent the loss of cells or solution. Lid 60 may be configured to limit the motion of seal 50 relative to cover 100.

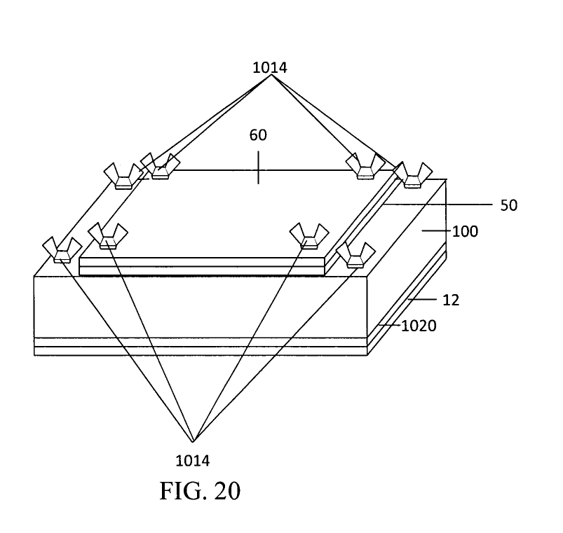

Referring now to FIG. 20, a perspective view of one embodiment of slide holder 10 is shown. Seal 1020 is shown positioned above base 12, and cover 100 has been placed on seal 1020. Seal 50 has been placed on cover 100, and lid 60 has been placed on seal 50. Screws 1010 have been placed through apertures 1012, apertures 1024, apertures 182, apertures 54 and apertures 62. Fasteners 1014 have been attached to screws 1010 to prevent the movement of base 12, seal 1020, cover 100, seal 50 and lid 60 relative to one another. Fasteners 1014 are shown as wing nuts, but it is contemplated that alternatives may include, for example purposes, nuts, clips or clamps.

Although reference has been made to screws 1010 and apertures 1012, apertures 1024, apertures 182, apertures 54 and apertures 62 it is contemplated that alternative means for attachment may be utilized. Contemplated means for attachment include, but are not limited to, snap fits, clips, clamps, rails, hooks, latches, temporary adhesives or permanent adhesives.

Generally, the method of using a microscope slide holder is disclosed herein, and many alterations would occur to one skilled in the art, and are contemplated as a part of the invention. This description of the procedure should be understood to encompass all possible embodiments of the microscope slide holder previously discussed. The method for using the microscope slide holder includes, generally: selecting a base with a plurality of chambers formed on the base, the plurality of chambers configured to receive and retain microscope slides; placing microscope slides within one or more of the chambers; adding a cell suspension to one or more of the microscope slides, and allowing cells to adhere to the slide. Further, the method may include placing a seal so that it covers the plurality of chambers; attaching a lid to the base; placing the microscope slide holder into the swinging-bucket rotor; activating the swinging-bucket rotor; deactivating the swinging-bucket rotor; removing the microscope slide holder from the swinging-bucket rotor; removing the lid from the base; removing the seal from the base; and removing the plurality of microscope slides from the base. Alternatively, the lid may be placed over the base rather than attached to it. A cover may be placed on the slide before adding cell suspension in an additional step. Further, in an additional step, the cover may be added after adding the cell suspension.

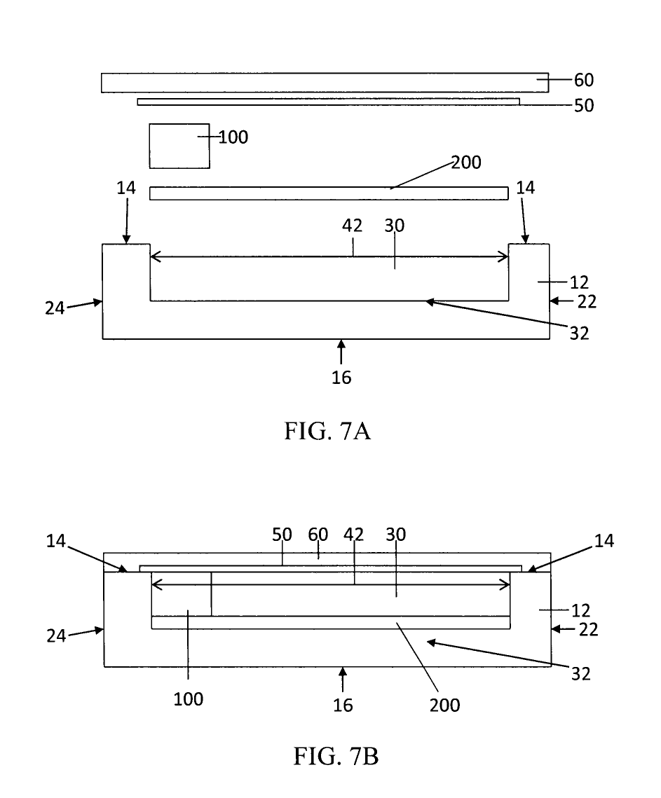

Referring to FIG. 7A, the cross section of a selected base 12 is shown with microscope slide 200 positioned above chamber 30. Cover 100 is shown positioned above microscope slide 200. Seal 50 is shown positioned above cover 100, and lid 60 is shown positioned above seal 50.

Now referring to FIG. 7B, the cross section of selected base 12 is shown with microscope slide 200 resting on floor 32 of chamber 30. Cover 100 has been placed such that it contacts microscope slide 200 and is otherwise retained by chamber 30. Seal 50 has been positioned such that it covers chamber 30. Finally, lid 60 has been attached to base 12 such that slide holder 10 is prepared to be placed into a centrifuge.

The slide holder may then be placed into a centrifuge. The centrifuge may then be activated, or turned on, such that the microscope slide holder 10 and microscope slides 200 are spun. The centrifuge may then be deactivated, or turned off. The microscope slide holder 10 may then be removed from the centrifuge and lid 60 and seal 50 may be removed. The microscope slides 200 may then be removed from the slide holder 10. The microscope slides 200 may be removed by overturning the slide holder 10, or through the use of a forceps, or through the use of an adhesive tape attached to the label area.

The above steps pertain to the embodiment disclosed in FIG. 1 and described above. However, it is contemplated that certain adjustments may be made to the method so that the embodiment disclosed in FIG. 5 and described above may be used.

The method of using the microscope slide holder may include the steps of selecting a base, inserting a plurality of microscope slides 200 into the plurality of chambers 30 through the plurality of apertures 80. In an additional step, a plurality of caps 210 may be placed in a plurality of apertures 80. The slide holder may then be placed in the centrifuge. The centrifuge may then be activated. After spinning the microscope slide holder 10 in the centrifuge for an appropriate period of time, the centrifuge may then be turned off. The slide holder 10 may then be removed from the centrifuge. Cap 210 may be removed from aperture 80, and microscope slide 200 may be removed from chamber 30 through aperture 80.

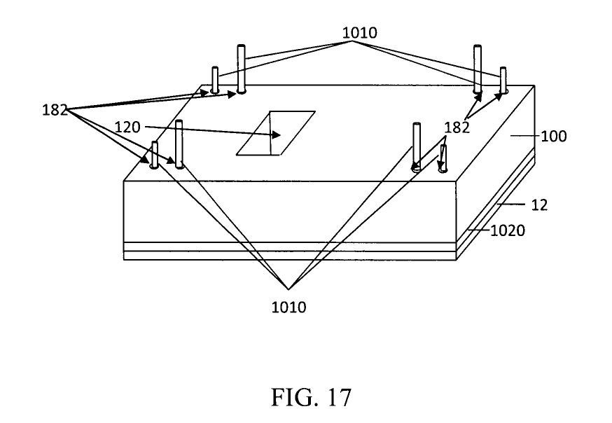

Referring now to FIG. 17, slide 200 may be positioned on base 12. Then, seal 1020 may be placed on base 12. Cover 100 may be placed on seal 1020. Thus, seal 1020, cover 100 and base 12 may easily be combined to provide an area for cells to be deposited on. Plurality of screws 1010 may then be placed through obscured apertures 1012, obscured apertures 1024, and apertures 182. Slide 200 may have been positioned on base 12 such slide 200 may be accessed through aperture 120 and obscured aperture 1022.

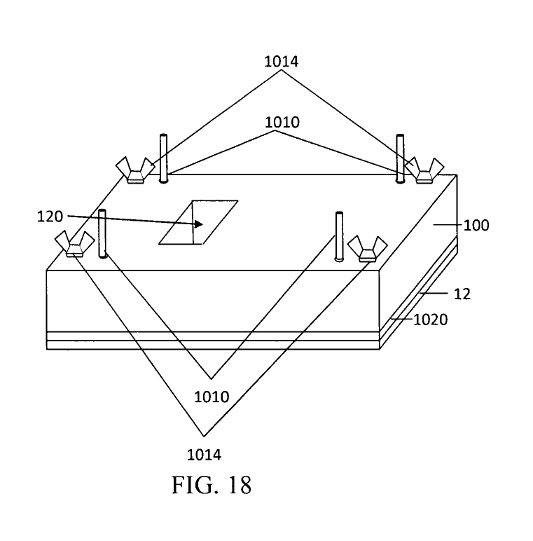

Referring now to FIG. 18, fasteners 1014 may then be placed on one or more screws 1010. Fasteners 1014 prevent the movement of base 12, seal 1020 and cover 100 relative to one another.

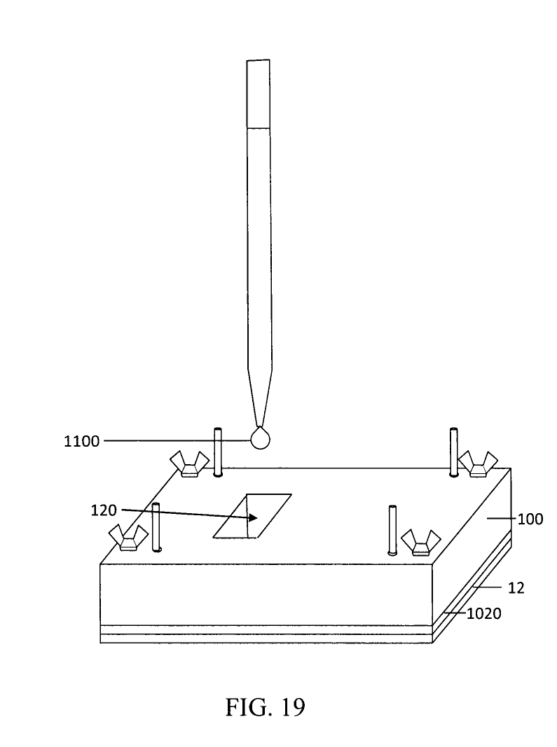

Now referring to FIG. 19, a solution 1100 may then be added to slide 200. Solution 1100 may be added to slide 200 through a single aperture 120 or alternatively through a plurality of apertures 120 to provide multiple sites to be investigated simultaneously.

Now referring to FIG. 20, a seal 50 may be then placed over cover 100. A lid 60 may then be placed over seal 50. In an additional step, additional fasteners 1014 may be placed on one or more screws 1010. Seal 50 may prevent the cross contamination or loss of cells of different slides 200.

Generally, the method of manufacturing a microscope slide holder is disclosed herein, and many alterations would occur to one skilled in the art, and are contemplated as a part of the invention. This description of the procedure should be understood to encompass all possible embodiments of the microscope slide holder previously discussed. The method of manufacturing the microscope slide holder includes, generally: fabricating a base, fabricating a lid to be attached to the base, fabricating a seal to be positioned between the lid and the base; positioning the seal between the lid and the base and attaching the lid to the base.

The method of manufacture may also include the steps of manufacturing a cover to be positioned between the lid and the base, and positioning the cover between the lid and the base. The method may also include manufacturing a second seal to be positioned between the cover and the base, and positioning the second seal between the cover and the base.

While embodiments of the invention have been illustrated and described in detail in the disclosure, the disclosure is to be considered as illustrative and not restrictive in character. All changes and modifications that come within the spirit of the invention are to be considered within the scope of the disclosure.

What is claimed is:

1. A microscope slide holder, comprising:
a base, with a top surface, a bottom surface, a left surface, a right surface, a front surface and a back surface, one or more chambers disposed on the base and configured to retain one or more microscope slides.

2. The microscope slide holder of claim 1, further comprising:
a seal configured to cover one or more chambers; and
a lid configured to cover the top surface of the base.

3. The microscope slide holder of claim 2, wherein:
the lid is configured to attach to the base.

4. The microscope slide holder of claim 1, wherein:
the one or more chambers are formed on the top surface of the base.

5. The microscope slide holder of claim 1, further comprising:
one or more apertures formed on the top surface; and
one or more apertures formed on the front surface configured to allow access to the one or more chambers.

6. The microscope slide holder of claim 5, further comprising:
one or more caps configured to fit within the one or more apertures formed on the front surface.

7. The microscope slide holder of claim 1, further comprising:
one or more covers configured to reduce access to an area of the one or more microscope slides.

8. The microscope slide holder of claim 7, wherein:
the one or more microscope slides have a label area; and
the one or more covers are configured to cover the label area of the one or more microscope slides.

9. The microscope slide holder of claim 7, wherein:
the one or more microscope slides have a perimeter and a label area; and
the one or more covers are configured to cover the label area of the one or more microscope slides and the perimeter of the one or more microscope slides.

10. The microscope slide holder of claim 7, wherein:
the one or more covers are configured to cover the one or more microscope slides except for an effective area for cell depositing.

11. The microscope slide holder of claim 7, wherein:
the one or more covers further comprises:
a means for removal.

12. The microscope slide holder of claim 7, wherein:
the one or more covers further comprises:
a means for interlocking with the base to prevent sliding of the one or more covers.

13. The microscope slide holder of claim 7, further comprising:
a lid configured to cover the top surface of the base; and wherein
the one or more covers are attached to the lid.

14. The method of using a microscope slide holder comprising:
selecting a base with one or more chambers;
placing one or more microscope slides within the one or more chambers;
placing one or more cells on the one or more microscope slides; and
allowing the one or more cells to contact and adhere to the slide.

15. The method of claim 14, further comprising:
selecting one or more covers;
placing the one or more covers over the one or more microscope slides; and
removing the one or more covers from the one or more microscope slides.

16. The method of claim 14, further comprising:
selecting one or more caps; and
placing the one or more caps in one or more apertures.

17. A method of claim 14, further comprising:
placing a lid onto the base, thereby assembling the microscope slide holder;
placing the microscope slide holder into a centrifuge;
activating the centrifuge;
deactivating the centrifuge;
removing the microscope slide holder from the centrifuge;
removing the lid from the base; and
removing the one or more microscope slides from the microscope slide holder.

18. A microscope slide holder comprising:
a base, with a top surface, a bottom surface, a left surface, a right surface, a front surface and a back surface, configured to fit within a swinging-bucket rotor centrifuge;
one or more chambers, configured to retain one or more microscope slides with an effective area for cell depositing and a label area, formed on the top surface of the base;
a lid configured to attach to the top surface of the base;
one or more covers, configured to fit within the one or more chambers and configured to reduce the effective area for cell depositing; and
wherein the one or more covers further comprises:
a means for removal.

19. A microscope slide holder, comprising:
a base;
at least one seal;
a cover configured to approximate the size and shape of a base;
one or more apertures formed on the cover, configured to provide access to an effective area for cell depositing; and
a lid configured to prevent the ejection of materials from the one or more apertures.

20. The microscope slide holder of claim 19, further comprising:
at least two seals.

21. The method of manufacturing a slide holder, comprising:
fabricating a base;
fabricating a lid to be attached to the base;
fabricating a seal to be positioned between the lid and the base;
positioning the seal between the lid and the base; and
attaching the lid to the base.

22. The method of manufacturing a slide holder of claim 21, further comprising:
fabricating a cover to be positioned between the lid and the base; and
positioning the cover between the lid and the base.

23. The method of manufacturing a slide holder of claim 22, further comprising:
fabricating a second seal to be positioned between the cover and the base; and
positioning the second seal between the cover and the base.
